(19) United States
(12) Patent Application Publication
(10) Pub. No.: US 2008/0250331 A1
(43) Pub. Date: Oct. 9, 2008

(54) Method and System of a Voting Based Wiki and Its Application to Internet Topic Directories

(76) Inventor: Atul Tulshibagwale, Chandler, AZ (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 12/098,405

(22) Filed: Apr. 4, 2008

Related U.S. Application Data
(60) Provisional application No. 60/910,200, filed on Apr. 4, 2007.

(51) Int. Cl. G06F 3/048

(52) U.S. Cl. 715/751

(57) ABSTRACT

A method and system of a voting on changes to a collaborative web page or topic hierarchy, e.g. a voting-based wiki. Information on a website is created, edited or deleted by end users and then voted upon before being accepted into the site. In the case of a voting based wiki for a topic hierarchy, under the normal course of operation, the topic hierarchy changes such as new topics being added, topics being moved or topics being deleted can be done without manual intervention. This allows free collaboration between all users or qualified users, and does not normally require manual intervention. If a topic is controversial (i.e. has received a number of votes greater than a threshold both for and against it), then it can be adjudicated by a moderator.

### CROSS-REFERENCE TO RELATED APPLICATIONS

This application claims priority to U.S. provisional patent application No. 60/910,200, filed on Apr. 4, 2007, which is incorporated herein by reference.

### BACKGROUND

1. Field

Aspects of the present invention are related to Internet services associated with collaborative authoring and in particular, operation of Internet or open directories/web directories, including creating, deleting or modifying web content.

2. Background

Currently topic directories or topic hierarchies are used for categorizing web content such as blogs, videos, etc., into specific topics that they may be about. Such Internet topic directories, also knows as category directories or web catalogs/directories, can organize a collection of links to other websites. A topic hierarchy can be created centrally by an organization/company or can be constructed by community involvement.

There are two major types of directories: 1) proprietary directories such as the Yahoo!™ Internet Directory and 2) open directories such as the one from the Open Directory Project, also known as DMOZ, which is widely used by other websites such as Google™. Proprietary directories such as Yahoo!™ do not typically disclose mechanisms of creating their topic directories. However, they appear to rely on a loosely affiliated community of experts for editing categorization of specific topic areas. The Open Directory Project also relies on a network of designated individuals who volunteer to moderate the creation and or modification of topic hierarchies. These individuals/users are deemed as “editors” of certain topic areas. These volunteer editors, for a specified topic area, can change the categories in a particular topic area and the results are immediately visible on the directory.

Other current systems used for categorizing and presenting web content include wikis. Wikis are websites which allow users to add, change or delete its content. Some wikis are protected, requiring users to be authenticated before they can make any changes; others are unprotected allowing for direct editing by anyone. Some wikis also require any modification by users (authenticated or unauthenticated) to be reviewed by a select group of moderators before the changes are incorporated into the content published by the wiki.

The problem encountered in current approaches is that direct editing causes instability in that changes are based on the last edit and also on the last editor's opinion, not necessarily one commonly accepted. Direct editing can also lead to abuse or malicious modification. On the other hand, manual intervention by a group of moderators for reviewed wikis/topic directories also leaves the final content in the hands of a select group, not necessarily the community and further suffers from the inefficiency of constant manual intervention.

As such there is a need for a more stable environment for creation and changes to topic directories and other web content. There is need for an opinion on organizing and presenting information that reflects a more accurate assessment of the community as a whole or of the field of expertise such that the opinion of a select few does not ultimately control the final product. In addition, there exists a need for less manual manipulation by this group of a select few and a more automated and reliable approach to modifying web content and at the same time lessen the potential for abuse to such systems which allow for non authenticated user manipulation.

### SUMMARY

A method and system of a voting based wiki based on an embodiment of the current invention therefore solves these problems in having end users (whether authenticated or not) to vote on changes to content on the website. This removes the requirement for constant manual intervention as well as provides a more accurate reflection on community opinion.

A voting wiki provides stable content because changes must be voted for by a significant number of members of a community and at the same time will be efficient as the burden of decisions and judgment will not lie upon a select few individuals.

According to an embodiment, the content would be proposed and voted upon by end-users, the change would occur automatically if a minimum number of votes for a change is received and the number of votes for change are greater by a certain margin than the number of votes for not changing the content. With multiple conflicting proposed changes, the one with the most votes is adopted. If both for and against votes have met a threshold requirement, i.e. the vote is close, a moderator can then finally adjudicate the proposal. In an embodiment, a human moderator may manually adjudicate the proposal.

An embodiment of the invention comprises a method and system of a voting-based wiki. Information on a website is created, edited or deleted by end users and then voted upon before being accepted into the site. In the case of a voting based wiki for a topic hierarchy, under the normal course of operation, the topic hierarchy changes such as new topics being added, topics being moved or topics being deleted can be done without manual intervention. The technique allows free collaboration between all users or qualified users, and does not normally require manual intervention. Only if a topic is controversial (i.e. has received a number of votes greater than a threshold both for and against it), then it can have manual intervention to resolve the issue.

In an embodiment of the present invention, there is provided a method for voting on modifications to a collaborative web page, comprising: viewing content of said collaborative web page; proposing a modification to said content of said collaborative web page; presenting a modification proposal for voting on said modification; opening a voting period; voting on said modification; closing said voting period and accounting for the votes on said modification; determining a status of said modification proposal based on said accounting resulting in acceptance, rejection or adjudication of the modification proposal.

In an embodiment of the present invention, there is provided a system for voting on modifications to a collaborative web page, comprising: a user interface for allowing users to view a plurality of content of said collaborative web page, propose modifications to said content of said collaborative web page, view modification proposals to said content of said collaborative web page, and vote on whether to accept or reject said modifications; an administrator interface for allowing administrators of said collaborative web page to view modification proposals to said content of said collaborative web page, accept or reject said modification proposals, incorporate said modifications into said content of said collaborative web page, contact users regarding modification proposals, and select moderators to determine whether to accept or reject modification proposals where user votes on said modification proposals are split or substantially split according to a designated margin; and a moderator interface for allowing designated moderators to view modification proposals where user votes on said modification proposals are split or substantially split according to a designated margin, and to determine whether to accept or reject modification proposals where user votes on said modification proposals are split or substantially split according to a designated margin.

Implementations of the present invention include a method or process, an apparatus or system, or computer software on a computer-readable medium.

These and other embodiments of the present invention are further made apparent, in the remainder of the present document, to those of ordinary skill in the art.

### BRIEF DESCRIPTION OF DRAWINGS

These and other objects, features and advantages of the present invention are better understood by reading the following detailed description of the preferred embodiment, taken in conjunction with the accompanying drawings, in which:

FIG. 1 depicts a screen shot image representing the step of creating a proposal, according to an embodiment of the present invention.

FIG. 2 depicts a screen shot image representing the step of voting on proposals, according to an embodiment of the present invention.

### DETAILED DESCRIPTION OF EMBODIMENTS

According to embodiments of the present invention, there is a system and method of a voting based wiki for creation and modification of web content. In particular there is a described a voting based wiki applied to Internet topic directories. However, the system and method of the voting wiki technique can be applied to a number of different areas as well, where new information is created by members of a community and then voted upon before being accepted into the site. For instance, an example of other applications in which the voting based technique may be applied is an online encyclopedia like Wikipedia, other community or topic specific sites as well as other collaborative writing efforts.

In an embodiment of the present invention, a system and method of a voting wiki is described. The system of voting wiki is an online system on which multiple users can visit using a network client such as a web browser. Client types may include any device capable of connecting to the network. The system of a voting wiki includes the necessary server(s), database(s), memory, processor(s) and computer system components which may be required to perform the algorithms of the system and result in providing the voting wiki. The system also includes the necessary interfaces between the system and the different users which interact with the system. In summary, the method of voting comprises the steps of a user viewing content of a wiki; proposing a modification to the wiki; presenting the modification proposal for voting; closing the voting period; and accounting for the votes; wherein the proposal is deemed accepted, rejected or adjudicated.

If the user desires that the content be changed in any way for example, new content be added, existing content be moved or deleted or a combination of thereof, the user creates a modification proposal. The modification proposal is open for voting for a certain period of time or until some other criteria are met, such as receiving the required votes in order to enact a change.

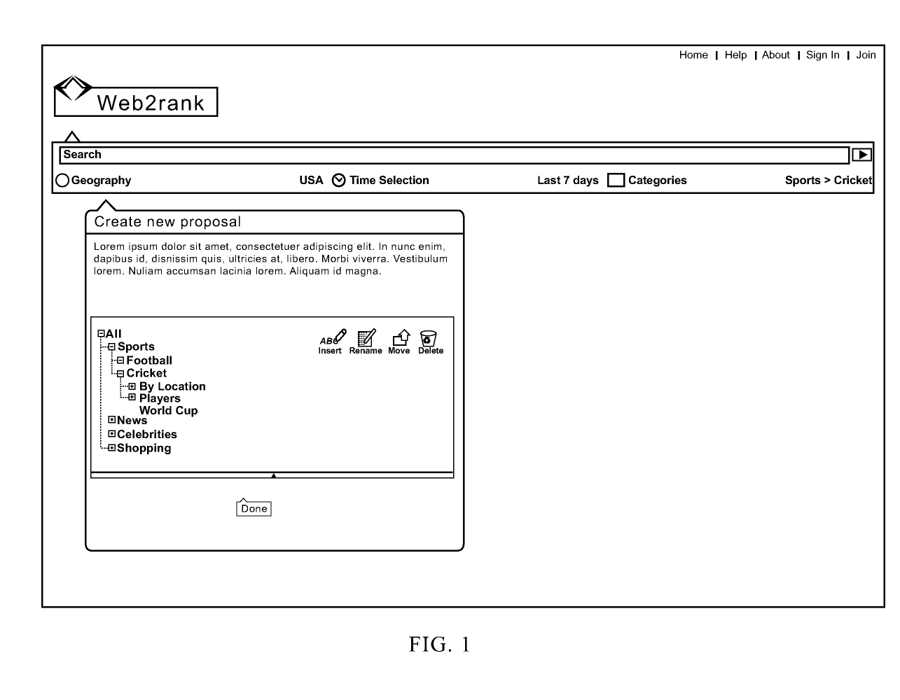

As illustrated in FIG. 1, a proposal is created by a user with reference to an Internet topic directory. As shown, the user is reviewing the content under a sports category for example, and is presented with options for editing existing content or creating new content. A user may insert content, rename content, move content or delete content according to an embodiment of the present invention.

Voting is open for members of the online community. There are selection criteria used in determining which users are able to vote, the criteria including members in a particular group or authenticated members, or authenticated members with certain credentials. Examples of selection criteria include, but are not limited to, (1) authenticated users, (2) authenticated users who are also bloggers, (3) an authenticated user can vote on a proposal that makes changes to a topic-sub hierarchy under a topic X if the user already has a blog that also has a topic under the sub-hierarchy X.

Once the voting closes as a result of the time period expiring or some other criteria being met, the result is accounted for. The result may include the proposal being accepted, the proposal being rejected, or the proposal being adjudicated. A proposal is accepted when a number of users above a certain threshold have voted for the proposal and the number of opposing votes is less than a certain other threshold. A proposal is rejected when a number of users above a certain threshold have voted against the proposal and the number of votes for the proposal is very low. A proposal is to be adjudicated when the number of votes “for” and the number of votes “against” the proposal are both greater than a certain threshold. This threshold may be different than the thresholds mentioned above.

If the proposal is accepted, the results are incorporated into the wiki and users are able to see it as a part of the wiki. If the proposal is rejected/discarded, no changes are made to the wiki. If the proposal is required to be adjudicated, then a moderator, for example, one who may be a special member of the community or a designated person outside the community, is required to determine whether or not the proposal may be accepted or rejected.

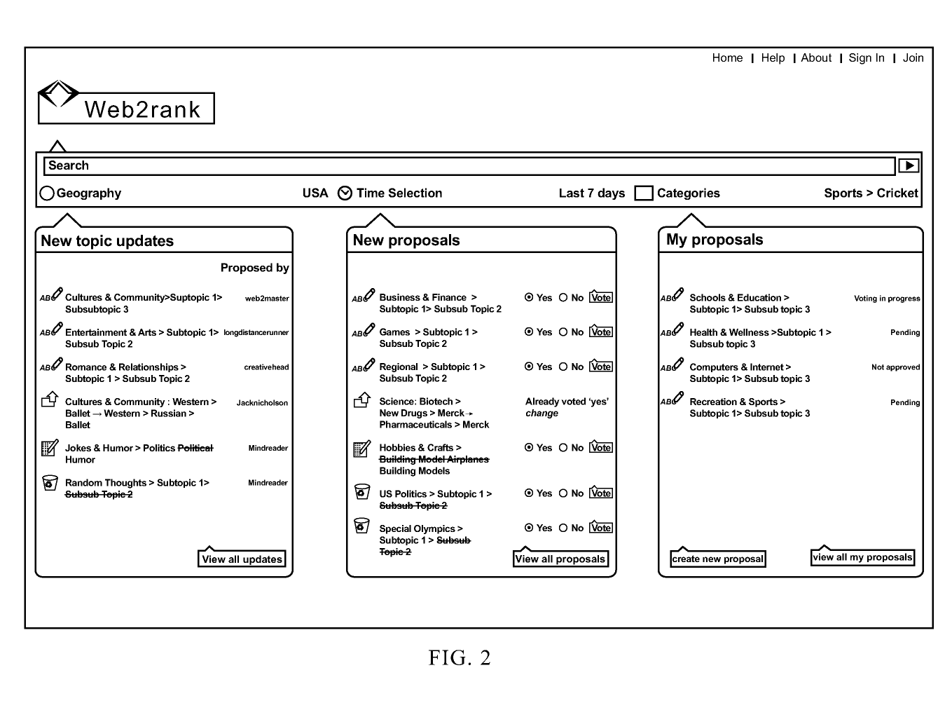

As illustrated in FIG. 2, the method of voting on proposals in a topic directory is shown in a screenshot presented to the user, according to an embodiment of the present invention. As shown, the user is presented with sections including “New Topic Updates”; “New Proposals” to be voted upon; and “My Proposals” including the user's proposals to the topic directory. In the New Topic Updates section a listing of topics updated are presented including the topic and subtopic indication as well as the proponent of the change. Next to each topic update is an indicator describing the type of change proposed, for instance content has been inserted, content has been moved to another topic or subtopic area, and content has been renamed or deleted as shown by the strikethrough. Other indicators are also possible and other techniques for showing content change such as underlying or brackets for example. The user may click on the topic/subtopic description to view, in another page, the changes in more detail.

As further described in FIG. 2, a New Proposal section presents the user with a listing of the new proposals, also with the indication as to the type of proposal, and further with the opportunity to vote on content changes. The user is given the option to vote yes or no to accept or decline the change respectively and enter the vote. The user is also presented the status of proposals voted upon by the user and the opportunity to change a vote for instance if the time period for voting has not ended. In the My Proposal section, the user is presented with a listing of the status of all the user's proposals presented on the voting wiki. The listing again is shown with topic and subtopics with an indication as to the type of change made to the content. The user is presented with the status of the current vote including whether the voting is in progress for instance until the time period for voting is over; the result is pending for instance in the case an adjudication is required; the results is not approved or the result is approved. The user is also presented with the opportunity to create a new proposal which will lead back to a page for creating proposals such as described in FIG. 1. The vote of user who creates a proposal is automatically counted as a yes for any proposal such user creates.

The idea of voting on content proposals to make them final can be applied to a number of areas such as online encyclopedias and other reference guides, rules and regulations of a group or collective, or collaborative writing such as story writing.

The voting wiki according to embodiments of the present invention provide a mechanism for a community to have a more stable content that will accurately reflect the opinions, likes, dislikes of an online community. It will be less vulnerable to abuse and malicious modifications as the changes require a consensus from the community. Manual intervention is not required unlike a reviewed wiki and the voting wiki system may still be protected or unprotected.

Although specific embodiments of the present invention have been described above in detail, the description is merely for purposes of illustration, and the invention is not so limited. Various modifications of, and equivalent steps corresponding to, the disclosed aspects of the exemplary embodiments, in addition to those described above, can be made by those skilled in the art without departing from the spirit and scope of the present invention, the scope of which is to be accorded the broadest interpretation so as to encompass such modification and equivalent structures.

What is claimed is:

1. A method for voting on modifications to a collaborative web page, comprising:
viewing content of said collaborative web page;
proposing a modification to said content of said collaborative web page;
presenting a modification proposal for voting on said modification;
opening a voting period;
voting on said modification;
closing said voting period and accounting for a plurality of votes on said modification;
determining a status of said modification proposal based on said accounting wherein
for a majority of said votes in favor of said modification then said modification proposal is deemed accepted, and incorporating said modification into said content of said collaborative web page;
for a majority of said votes opposed to said modification then said modification proposal is deemed rejected; and
for said votes accounted as split or substantially split according to a designated margin then said modification proposal is deemed to be adjudicated, and determining whether said modification proposal should be accepted or rejected.

2. The method of claim 1, wherein determining whether said modification proposal should be accepted or rejected includes providing a moderator to determine acceptance of said modification proposal.

3. The method of claim 2, wherein said moderator is a designated member of a community of said collaborative web page.

4. The method of claim 2, wherein said moderator is a designated person outside of a community of said collaborative web page.

5. The method of claim 1, wherein for a majority of said votes in favor of said modification then said modification proposal is deemed accepted only after attaining at least a designated threshold number of minimum votes in favor of said modification.

6. The method of claim 5, wherein said modification proposal is deemed accepted only after attaining at least a designated threshold number of votes in favor of said modification and said votes opposed to said modification is less than another designated threshold number.

7. The method of claim 1, wherein said voting on said modification is authorized only for authenticated users of said collaborative web page.

8. The method of claim 1, wherein said voting on said modification is authorized only for users of said collaborative web page who conform to designated selection criteria.

9. The method of claim 1, wherein a user's vote on said modification is changeable before said closing of said voting period.

10. The method of claim 1, wherein multiple conflicting modification proposals may be voted on in a voting period, and a modification proposal with the most votes is deemed accepted.

11. The method of claim 1, wherein proposing a modification to said content of said collaborative web page includes displaying the modification proposal for other users to view and vote on.

12. A system for voting on modifications to a collaborative web page, comprising:
a user interface for allowing users to view a plurality of content of said collaborative web page, propose modifications to said content of said collaborative web page, view modification proposals to said content of said collaborative web page, and vote on whether to accept or reject said modifications;
an administrator interface for allowing administrators of said collaborative web page to view modification proposals to said content of said collaborative web page, accept or reject said modification proposals, incorporate said modifications into said content of said collaborative web page, contact users regarding modification proposals, and select moderators to determine whether to accept or reject modification proposals where a number of user votes on said modification proposals are split or substantially split according to a designated margin; and
a moderator interface for allowing designated moderators to view modification proposals where a number of user votes on said modification proposals are split or substantially split according to a designated margin, and to determine whether to accept or reject modification proposals where a number of user votes on said modification proposals are split or substantially split according to a designated margin.

13. The system of claim 12, wherein said moderator is a designated member of a community of said collaborative web page.

14. The system of claim 12, wherein said moderator is a designated person outside of a community of said collaborative web page.

15. The system of claim 12, wherein said voting on whether to accept or reject said modifications is allowed only for authenticated users of said collaborative web page.

16. The system of claim 12, wherein said voting on whether to accept or reject said modifications is allowed only for users of said collaborative web page who conform to designated selection criteria.

17. The system of claim 12, wherein a user's vote on said modification is changeable before said closing of said voting period.

18. The system of claim 12, wherein multiple conflicting modification proposals may be voted on in a voting period, and a modification proposal with the most votes is deemed accepted.

19. The system of claim 12, wherein a modification proposal is automatically accepted for a majority of said votes in favor of said modification and after attaining a designated threshold number of minimum votes in favor of said modification.

20. The system of claim 19, wherein said modification proposal is automatically accepted further after a number of votes opposed to said modification is less than another designated threshold number.
